(19) United States
(12) Patent Application Publication
(10) Pub. No.: US 2013/0025198 A1
(43) Pub. Date: Jan. 31, 2013

(54) PLANTING DEVICE

(71) Applicant: Po An TENG, Shenzhen (CN)

(72) Inventor: Po An TENG, Shenzhen (CN)

(21) Appl. No.: 13/409,746

(22) Filed: Mar. 1, 2012

(30) Foreign Application Priority Data
Jul. 27, 2011 (CN) 201120267207.7

(51) Int. Cl. A01G 9/02

(52) U.S. Cl. 47/65.6

(57) ABSTRACT

A planting device includes a plurality of planting bodies. Each planting body has wall holes bottom holes thereon. Each plating body further comprises connection posts, connection holes and stop board at two ends thereof. The connection posts of one planting body are engaged with the connection holes of the next planting body so as to form the planting device. The wall holes and the bottom holes provide better permeability for soil. The present invention has a simple configuration and is convenient for use.

### BACKGROUND OF THE INVENTION

1. Field of the Invention

The present invention relates to a planting device, and more particularly to a planting device for potted plants.

2. Description of the Prior Art

Conventional planting pots may influence the growth of potted plants because the plants are watered too much or less water to cause the plants decayed or withered. If the plants are not watered appropriately, the potted plant may be ill to infect other potted plants nearby. The conventional planting pot is unable to effectively prevent spread of diseases and automatically water the plants, so it cannot be used widely. Accordingly, the inventor of the present invention has devoted himself based on his many years of practical experiences to solve these problems.

### SUMMARY OF THE INVENTION

The primary object of the present invention is to provide a planting device which comprises a plurality of planting bodies. Each planting body has a plurality of wall holes on side walls thereof and a plurality of bottom holes on a bottom thereof. Each plating body further comprises a plurality of connection posts disposed close to one end edge thereof and a plurality of connection holes disposed close to another end thereof. The plurality of connection posts corresponds to the plurality of connection holes. Two ends of each planting body are connected with two stop boards. The stop boards are located inside the planting body adjacent to the connection posts and the connection holes, respectively. Each planting body further has engaging recesses corresponding in position to the stop boards for engagement of the stop boards. The stop boards can be detached from the planting body. Each planting body further has fixing feet at the corners of the bottom thereof. The connection posts of one planting body are engaged with the connection holes of the next planting body so as to form the planting device. A plurality of planting devices can be connected together to form a large-size planting device. The wall holes and the bottom holes provide better permeability for soil. The present invention has a simple configuration and is convenient for use.

### BRIEF DESCRIPTION OF THE DRAWINGS

FIG. 1 is a top view according to a preferred embodiment of the present invention;

FIG. 2 is a perspective view according to the preferred embodiment of the present invention; and

FIG. 3 is a side view according to the preferred embodiment of the present invention.

### DETAILED DESCRIPTION OF THE PREFERRED EMBODIMENTS

Embodiments of the present invention will now be described, by way of example only, with reference to the accompanying drawings.

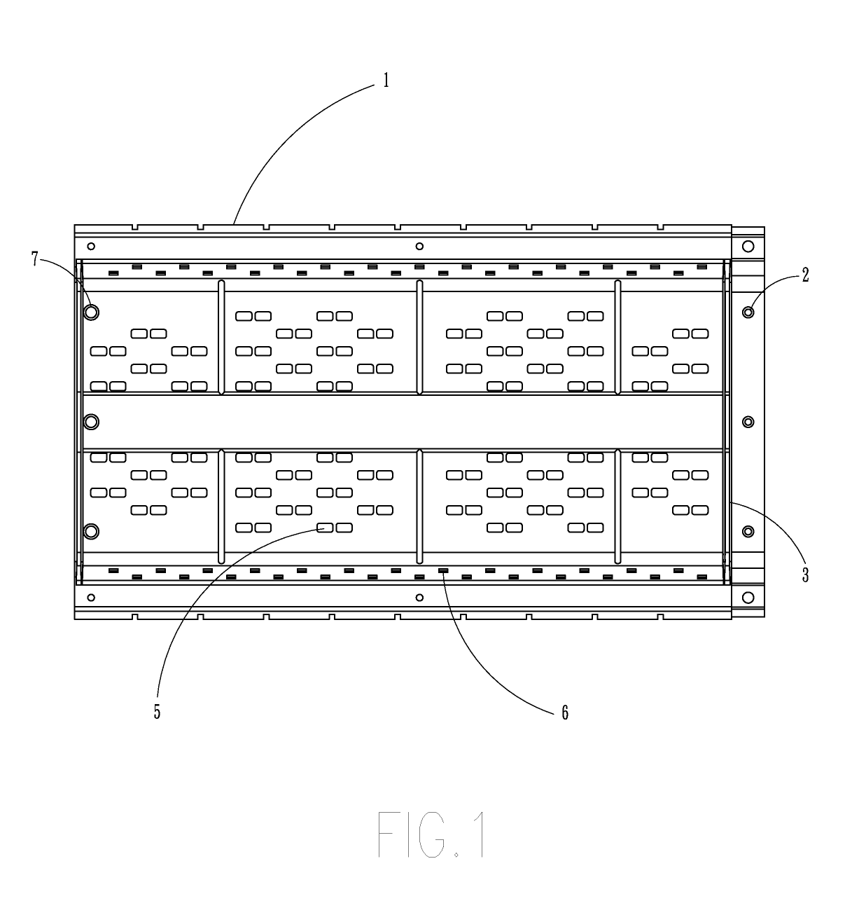

As shown in FIG. 1 through FIG. 3, the planting device according to a preferred embodiment of the present invention comprises a plurality of planting bodies (1). Each planting body (1) has a plurality of wall holes (6) on side walls thereof and a plurality of bottom holes (5) on a bottom thereof. Each plating body (1) further comprises a plurality of connection posts (2) disposed close to one end edge thereof and a plurality of connection holes (7) disposed close to another end thereof. The plurality of connection posts (2) corresponds to the plurality of connection holes (7). Two ends of each planting body (1) are connected with two stop boards (3). The stop boards (3) are located inside the planting body (1) adjacent to the connection posts (2) and the connection holes (7), respectively. Each planting body (1) further has engaging recesses corresponding in position to the stop boards (3) for engagement of the stop boards (3). The stop boards (3) can be detached from the planting body (1). Each planting body (1) further has fixing feet (4) at the corners of the bottom thereof. The connection posts (2) of one planting body (1) are engaged with the connection holes (7) of the next planting body (1) so as to form the planting device.

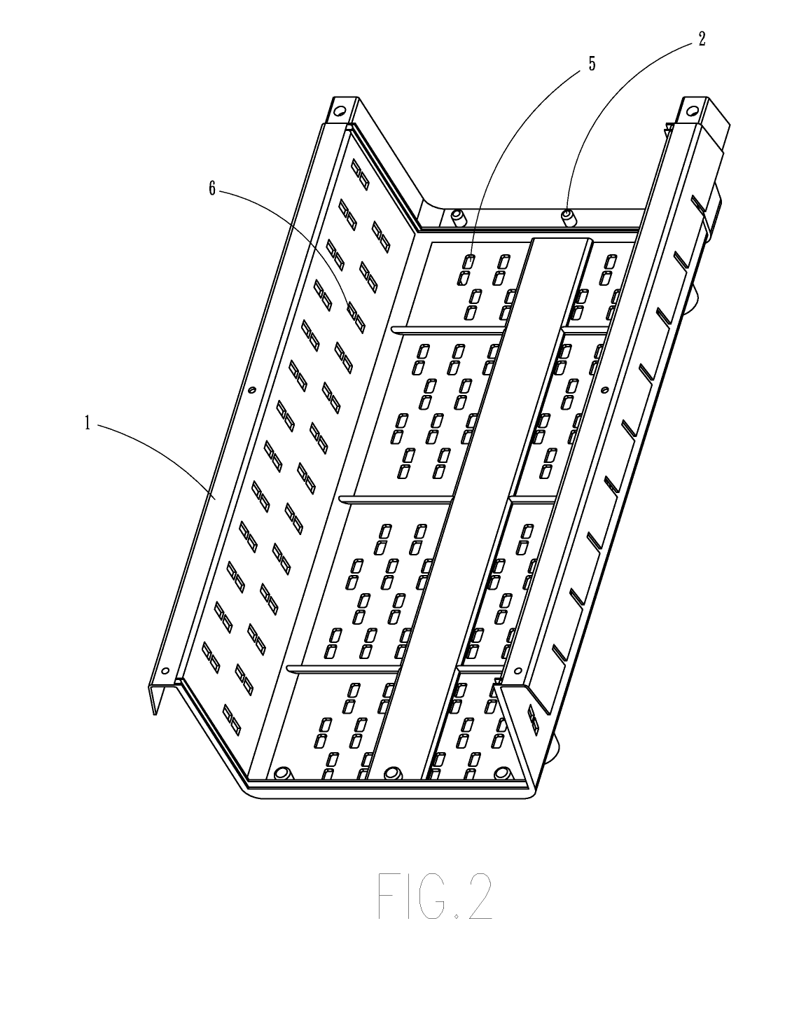

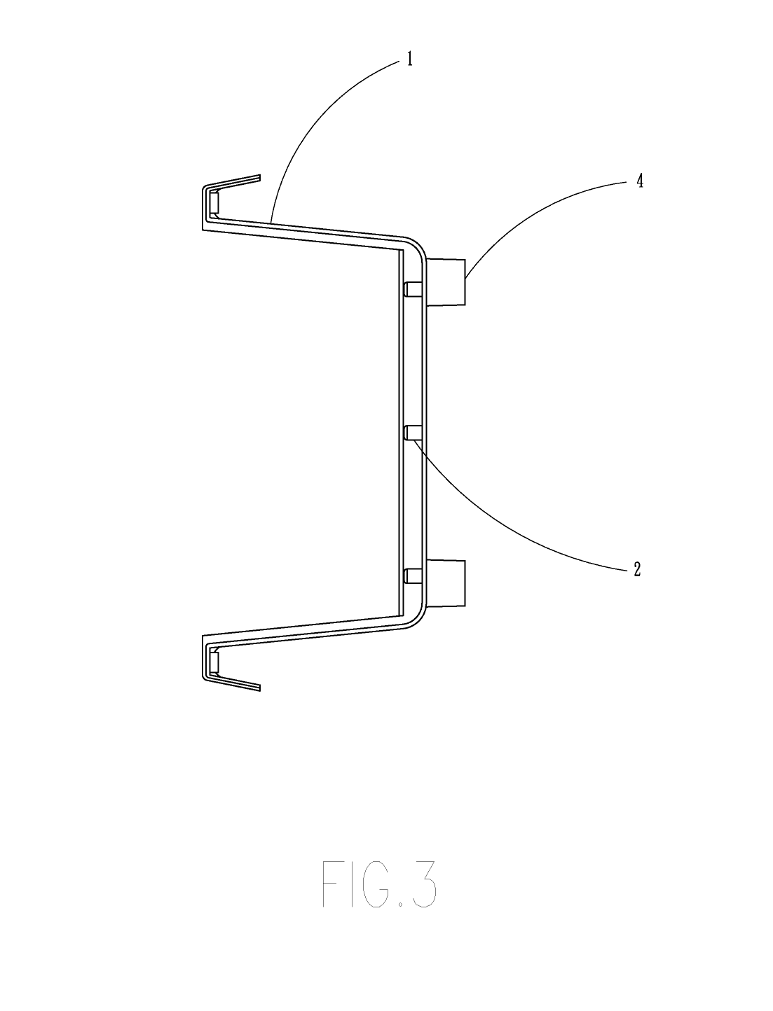

FIG. 1 is a top view according to a preferred embodiment of the present invention. FIG. 2 is a perspective view according to the preferred embodiment of the present invention. FIG. 3 is a side view according to the preferred embodiment of the present invention. The connection posts (2) of one planting body (1) are connected with the connection holes (7) of the next planting body (1). The stop board (3) is located between two adjacent planting bodies (1), so that the spaced planting bodies (1) can be planted with different plants as desired to increase variety of the potted plants. When one of the plants of the plurality of planting bodies (1) is ill, the stop boards (3) between the planting bodies (1) can be used to isolate the disease and prevent spread of the disease. The wall holes (6) and the bottom holes (5) provide better permeability for soil, preventing too much water in the planting device so as to save water. A water hose can be placed on the planting device. When watering the plants, the user just turns on the switch and the water will automatically flow in the planting bodies (1). The present invention has a simple configuration and is convenient for use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A planting device comprising a plurality of planting bodies, each planting body having a plurality of wall holes on side walls thereof and a plurality of bottom holes on a bottom thereof, each plating body further comprising a plurality of connection posts disposed close to one end edge thereof and a plurality of connection holes disposed close to another end thereof, the plurality of connection posts corresponding to the plurality of connection holes, two ends of each planting body being connected with two stop boards, the connection posts of one planting body being engaged with the connection holes of the next planting body to form the planting device.

2. The planting device as claimed in claim 1, wherein the stop boards are located inside the planting body adjacent to the connection posts and the connection holes, respectively.

3. The planting device as claimed in claim 1, wherein each planting body further has engaging recesses corresponding in position to the stop boards for engagement of the stop boards.

4. The planting device as claimed in claim 3, wherein the stop boards are detachable.

5. The planting device as claimed in claim 1, wherein each planting body further has fixing feet at corners of the bottom thereof.
